(19) United States
(12) Patent Application Publication
(10) Pub. No.: US 2026/0162132 A1
(43) Pub. Date: Jun. 11, 2026

(54) CUSTOMIZED INTERFACES BASED ON USER ENGAGEMENT VIA SETTLEMENT DATA

(71) Applicant: Brightree LLC, Peachtree Corners, GA (US)

(72) Inventors: Ravikannan Sivaraj, Coimbatore (IN); Samsudhin Habeeb, Chennai (IN); Akash Sujith Visuvasam, Thanjavur (IN); Jaimini Sankhavaram PANINI, Atlanta, GA (US); Akilesh NATARAJAN, Tucker, GA (US); Christopher Douglas BENSON, Overland Park, KS (US)

(21) Appl. No.: 19/408,021

(22) Filed: Dec. 3, 2025

Related U.S. Application Data
(60) Provisional application No. 63/728,526, filed on Dec. 5, 2024.

(51) Int. Cl. G06Q 30/0201; G06F 3/0481

(52) U.S. Cl. CPC G06Q 30/02011; G06F 3/0481

(57) ABSTRACT

Techniques for improved engagement evaluation and interface generation are provided. Settlement data for a patient is accessed, the settlement data corresponding to a plurality of prior requests. Based on the settlement data, an engagement score is generated for the patient, comprising generating a loyalty score, a willingness score, and a capability score based on the first settlement data. Based at least in part on the engagement score, an interface configuration is generated. An interface is provided, to the first patient, in accordance with the interface configuration.

### CROSS-REFERENCE TO RELATED APPLICATIONS

This application claims benefit of co-pending U.S. provisional patent application Ser. No. 63/728,526 filed Dec. 5, 2024. The aforementioned related patent application is herein incorporated by reference in its entirety.

### INTRODUCTION

Embodiments of the present disclosure generally relate to graphical user interfaces (GUIs). More specifically, embodiments relate to evaluating settlement data to predict engagement and customize computer interfaces.

A wide variety of computer interfaces (e.g., graphical or visual interfaces, tactile interfaces, audio interfaces, and the like) have been used to enable or facilitate interaction between users and computing devices. In many cases, relatively static interfaces serve as the primary (or only) source of information provided to the user, and/or the primary (or only) method to input information to the computing system. For example, in many systems, human designers manually create static interfaces (e.g., with static components and arrangements) without regard for how users will actually engage with the devices.

Improved systems and techniques to generate customized interfaces and notifications based on user engagement are desired.

### SUMMARY

According to one embodiment presented in this disclosure, a method is provided. The method includes: accessing first settlement data for a first patient, the first settlement data corresponding to a plurality of prior requests; generating, based on the first settlement data, a first engagement score for the first patient, comprising: generating a loyalty score based on the first settlement data; generating a willingness score based on the first settlement data; and generating a capability score based on the first settlement data; generating, based at least in part on the first engagement score, a first interface configuration; and providing, to the first patient, a first interface in accordance with the first interface configuration.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 depicts an example system for custom interface generation based on evaluating settlement data, according to some embodiments of the present disclosure.

FIG. 2 depicts an example workflow for generating customized interfaces based on engagement scores generated using settlement data, according to some embodiments of the present disclosure.

FIG. 3 depicts an example workflow for generating loyalty scores to facilitate customized interfaces based on settlement data, according to some embodiments of the present disclosure.

FIG. 4 depicts an example workflow for generating willingness scores to facilitate customized interfaces based on settlement data, according to some embodiments of the present disclosure.

FIG. 5 depicts an example workflow for generating capability scores to facilitate customized interfaces based on settlement data, according to some embodiments of the present disclosure.

FIG. 6 depicts an example workflow for generating engagement scores to facilitate customized interfaces based on settlement data, according to some embodiments of the present disclosure.

FIG. 7 depicts an example workflow for generating customized interfaces based on engagement scores, according to some embodiments of the present disclosure.

FIG. 8 is a flow diagram depicting an example method for generating customized interfaces based on engagement scores generated using settlement data, according to some embodiments of the present disclosure.

FIG. 9 is a flow diagram depicting an example method for generating loyalty scores to facilitate customized interfaces based on settlement data, according to some embodiments of the present disclosure.

FIG. 10 is a flow diagram depicting an example method for generating willingness scores to facilitate customized interfaces based on settlement data, according to some embodiments of the present disclosure.

FIG. 11 is a flow diagram depicting an example method for generating capability scores to facilitate customized interfaces based on settlement data, according to some embodiments of the present disclosure.

FIG. 12 is a flow diagram depicting an example method for generating engagement scores to facilitate customized interfaces based on settlement data, according to some embodiments of the present disclosure.

FIG. 13 is a flow diagram depicting an example method for generating customized interfaces based on engagement scores, according to some embodiments of the present disclosure.

FIG. 14 is a flow diagram depicting an example method for generating customized interfaces, according to some embodiments of the present disclosure.

FIG. 15 depicts an example computing device configured to perform various embodiments of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure provide apparatuses, methods, processing systems, and computer-readable mediums for engagement prediction and interface customization in computing devices.

In many cases, a variety of alerts, notifications, and interfaces can be used to exchange information with users regarding a wide variety of topics. For example, in medical contexts such as therapy (e.g., respiratory therapy, such as using a continuous positive airway pressure (CPAP) machine), users often use personal devices (e.g., smartphones, computers, tablets, and the like) to receive information related to the therapy (e.g., progress, goals, historical patterns) as well as to facilitate participation in the therapy (e.g., to order replacement parts or resupply consumables, to pay for current or prior orders, and the like).

In some environments, the user's engagement in the environment (e.g., between a healthcare provider and a patient) can be indicative of how the user responds to or interacts with the environment (e.g., how responsive they will be to updates or requests from their healthcare team). However, engagement is difficult to quantify in many settings. Further, in many cases, methods of interaction with the user (e.g., via various user devices) are static regardless of the engagement of the user. For example, many conventional systems use static notifications and interfaces, regardless of how engaged a patient is with respect to their respiratory therapy and/or provider. This lack of customization can further harm engagement (e.g., causing unengaged users to become even less engaged), in addition to reducing the efficacy of the systems (e.g., reducing therapy efficacy) and harming operations of providers (e.g., caused by delayed or unpaid invoices of the user).

In some embodiments of the present disclosure, techniques are provided to quantify user engagement using engagement scores. In some embodiments, engagement scores are used as a quantifiable metric to measure the level of engagement between a given user (e.g., a patient in a healthcare setting, such as engaged in respiratory therapy) and other users or systems (e.g., a provider that facilitates or provides the therapy and/or associated supplies). In some systems, a variety of techniques can be used to estimate user engagement. However, existing approaches generally rely on deeply personal and, at times, invasive information about the user. In some embodiments of the present disclosure, therefore, techniques are provided to predict user engagement using settlement data for the user (e.g., invoice history). For example, based on information relating to previous user requests (e.g., orders for supplies related to the therapy) and settlement details for these requests (e.g., when and how the user paid for the order), embodiments of the present disclosure can estimate user engagement without relying on more invasive or personal information about user habits or beliefs.

In some embodiments, as discussed below in more detail, this engagement prediction can be used to generate a variety of customizations for the specific user at the specific time. For example, in some aspects, user engagement metrics can be used to identify areas for improvement in terms of the therapy itself, and/or in terms of ensuring that the user will continue to engage (e.g., continue to order needed resupply for consumables) and/or that the user will complete or settle such orders (e.g., completing payment) without delay (or with reduced delay).

In some embodiments, as discussed in more detail below, the engagement score may be generated based on a variety of individual sub-scores, such as a loyalty score (e.g., indicating the level of loyalty of the user with respect to the entity), a willingness score (e.g., indicating the willingness of the user to make and settle requests), and/or a capability score (e.g., indicating the capability of the user to make and settle requests).

Advantageously, user engagement can be used to drive a wide variety of improved computer operations for the user. For example, customized interfaces based on user engagement may improve the probability that the user engages more in the future. As one example, based on the user engagement, the computing system may select optimal (or at least improved) methods of communication (e.g., from among a set of alternative communication channels), as well as selecting or generating optimized (or at least improved) content and arrangements of the communications. For example, one or more components of the GUI may be emphasized, deemphasized, relocated, added, removed, or otherwise modified based on the user's engagement. These dynamic interfaces can be used as more efficient and reliable input and output subsystems for the computing system, as compared to conventional interfaces. That is, relevant data may be both output by the system and ingested by the system in a more efficient and reliable manner, such as by reducing the number and/or complexity of steps needed to perform various actions via the interface, in a dynamic manner. This improves the functionality of the system itself, as well as other related technical fields (e.g., through improved data and client management).

### Example System for Custom Interface Generation Based on Evaluating Settlement Data

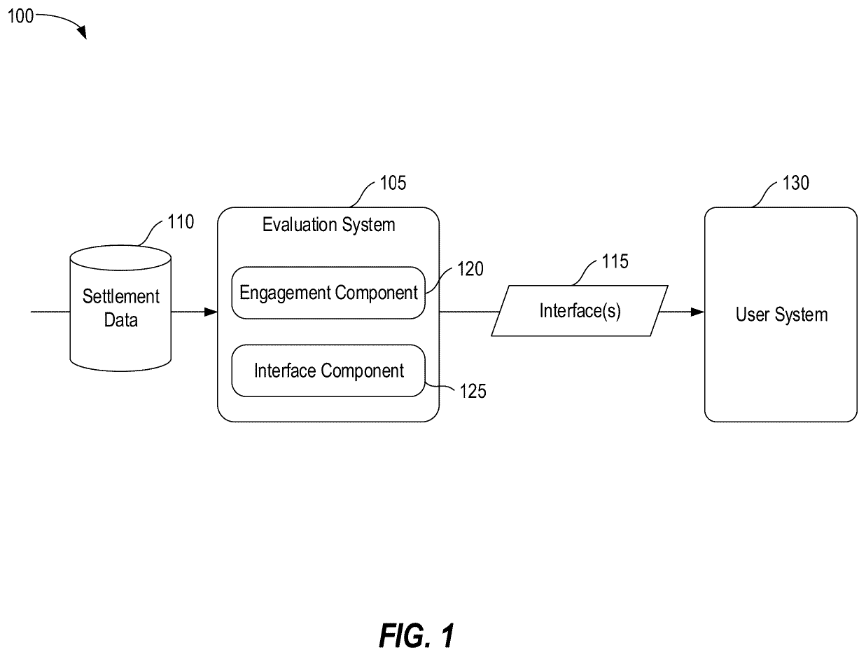

FIG. 1 depicts an example system 100 for custom interface generation based on evaluating settlement data, according to some embodiments of the present disclosure.

In the illustrated example, settlement data 110 is accessed by an evaluation system 105 to generate one or more customized interfaces 115. As used herein, “accessing” data may generally include receiving, requesting, retrieving, collecting, measuring, generating, obtaining, or otherwise gaining access to the data. For example, the evaluation system 105 may retrieve or receive the settlement data 110 from a remote repository, or from a local storage. Further, although a single repository of settlement data 110 is depicted for conceptual clarity, in some aspects, the settlement data 110 may generally be accessed from any number of sources. The evaluation system 105 is generally representative of a computing system capable of generating interfaces 115, and may be implemented using hardware, software, or a combination of hardware and software. Further, although a single discrete system is depicted for conceptual clarity, in some embodiments, the operations of the evaluation system 105 may be performed separately or jointly by any number of systems.

Generally, the settlement data 110 includes information relating to previous or historical requests and settlements for one or more users. For example, in the context of a respiratory therapy environment, the settlement data 110 may include information relating to user requests for therapy equipment (e.g., respiratory therapy devices and systems, masks, and the like), consumables (e.g., air tubes, filters, and the like), and any other items used in conjunction with the therapy. As one example, the settlement data 110 may include order records indicating each prior user request (e.g., each order for therapy items), when the request(s) were made (e.g., a date and/or time), when the request(s) were completed (e.g., when delivery or pickup was performed), when the request(s) were settled (e.g., when the user or another entity paid the invoice for the request, and/or when the user or another entity made each payment of a payment plan for the request), and the like. In some aspects, the settlement data 110 may indicate the amount(s) of each request (e.g., the number of items and/or the total price). Notably, in some embodiments, the settlement data 110 may lack detail regarding the particular contents of each request. For example, the settlement data 110 may indicate when the user requested a set of one or more items, without specifically indicating what the item(s) were.

In some embodiments, the evaluation system 105 accesses settlement data 110 to identify or retrieve record(s) relating to a given user (e.g., where the user was the individual that requested the item(s), received the item(s), and/or paid for the items) in order to generate engagement scores and/or customized interfaces for the given user.

In the illustrated system 100, the evaluation system 105 includes an engagement component 120 and an interface component 125. Although depicted as discrete components for conceptual clarity, the operations of the illustrated components (and others not depicted) may be combined or distributed across any number and variety of components.

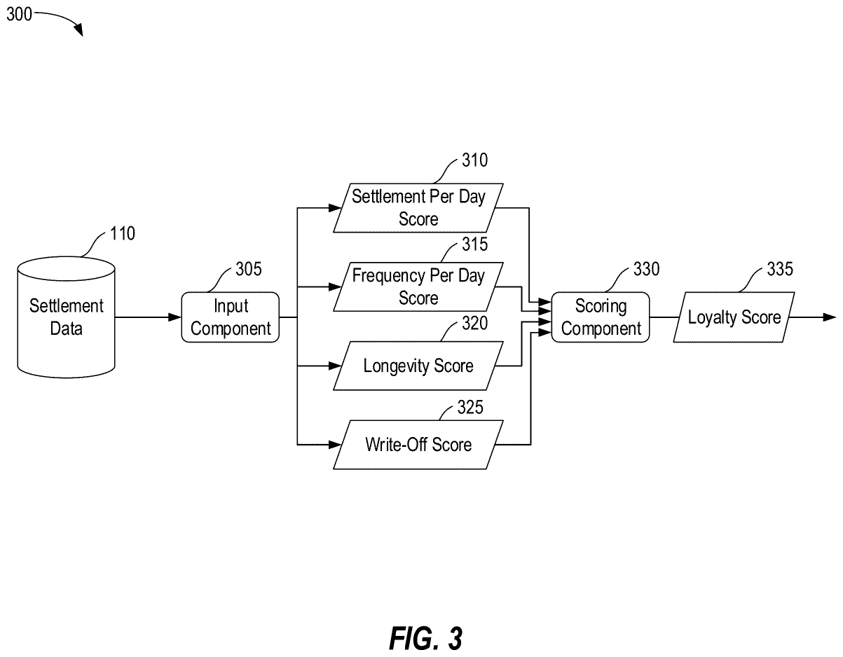

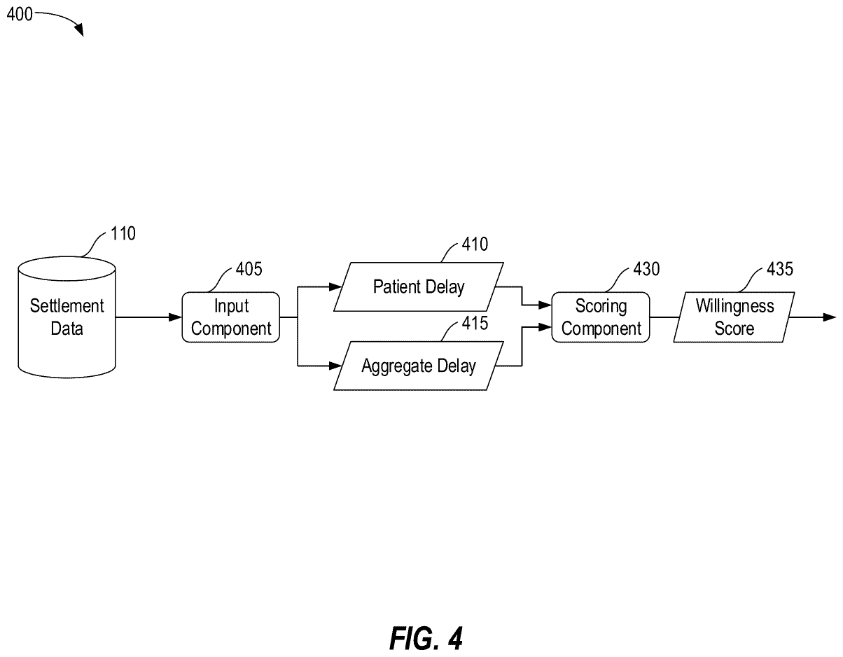

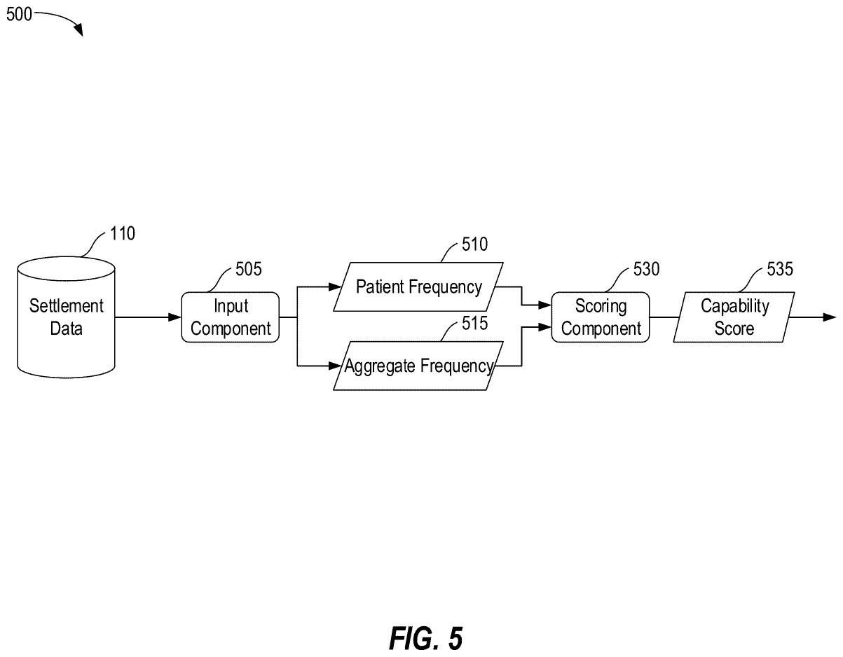

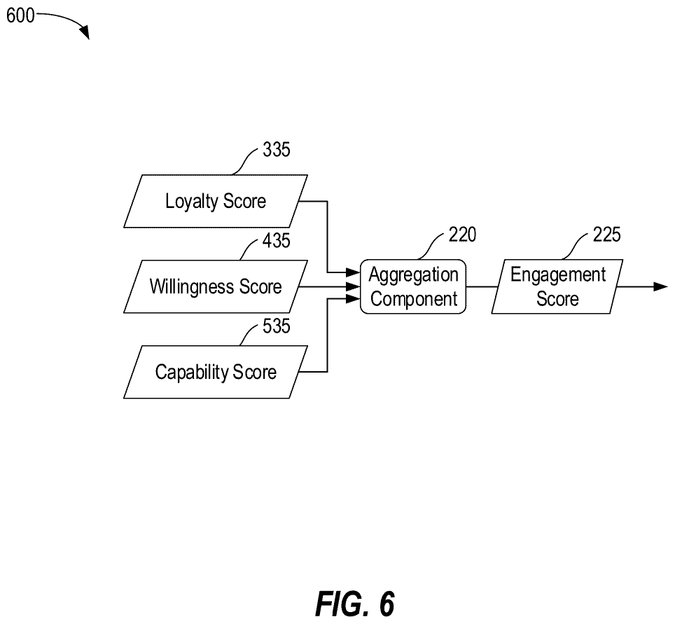

In the illustrated example, the engagement component 120 may generally be used to generate engagement scores for users based on the settlement data 110, as discussed in more detail below. For example, the engagement component 120 may generate loyalty scores as discussed in more detail below with reference to FIGS. 3 and/or 9, willingness scores as discussed in more detail below with reference to FIGS. 4 and/or 10, capability scores as discussed in more detail below with reference to FIGS. 5 and/or 11, and/or aggregated engagement scores as discussed in more detail below with reference to FIGS. 6 and/or 12.

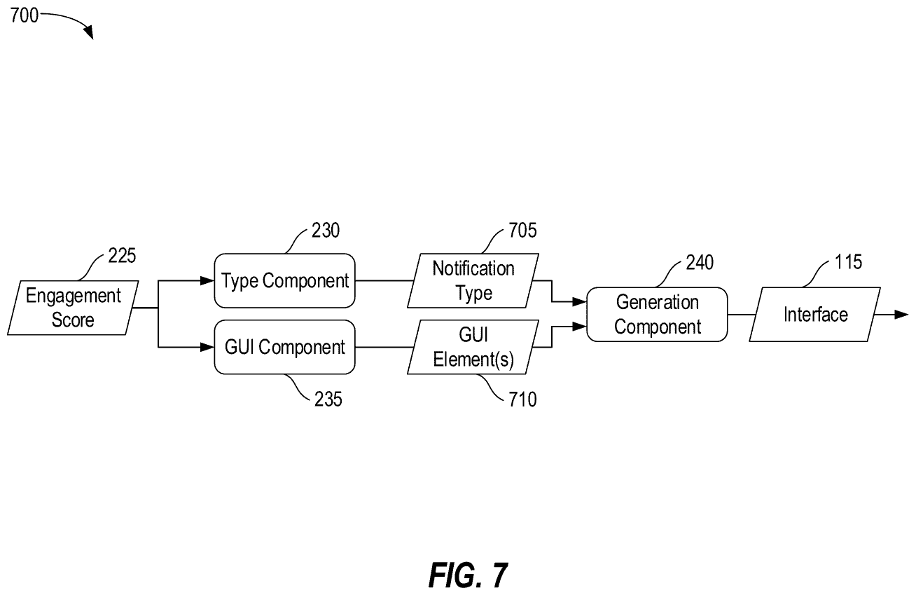

In the illustrated example, the interface component 125 may generally be used to generate dynamic and/or customized interface(s) 115 for users based on corresponding engagement scores, as discussed in more detail below. For example, the interface component 125 may select and/or generate particular interface configurations such as the notification type to use, the particular arrangement and selection of GUI elements to use, and the like, as discussed in more detail below with reference to FIGS. 7 and/or 13.

In some embodiments, the interfaces 115 may generally be used to provide and/or receive any information to and/or from users. In some embodiments, an interface 115 may include a request confirmation, reminder, and/or request for settlement (e.g., payment) of a request (e.g., an order for respiratory therapy equipment). For example, after a user enters a request for a new set of filters, an interface 115 may be generated to summarize the request and give relevant information (such as when delivery is expected, what item(s) were requested, and the like). In some embodiments, the interface 115 may include a prompt or request for settlement of the order (e.g., a button or other interface element asking the user to complete one or more payments), as discussed in more detail below.

In the illustrated system 100, the interface(s) 115 are provided to the user via a user system 130. The user system 130 is generally representative of any computing device(s) or system(s) used, by a user, to interact with their therapy. For example, the user system 130 may be used to monitor therapy progress, modify therapy settings, request additional support or items, settle (e.g., pay for) prior requests, and the like. Generally, the user system 130 may include a wide variety of computing devices, such as the user's smartphone, laptop, desktop computer, tablet, wearable device, and the like.

For example, the interface 115 may comprise or correspond to a notification (e.g., an email, a text, a push notification, a page or portion of an application executing on the user system 130, and the like), where the configuration of the interface is customized or dynamically generated by the evaluation system 105 to facilitate effective input and/or output of data, and/or to facilitate completion of the user's request(s). As one example, if the engagement score for the user indicates relatively low engagement (e.g., indicating that they may delay payment due to apathy), the interface 115 may be configured to emphasize or highlight aspects that will improve the probability of payment, such as by relocating, emphasizing, or otherwise modifying various GUI elements (e.g., increasing the prominence of a button to request a payment plan, rather than pay the entire amount immediately). As another example, if the engagement score for the user indicates relatively high engagement (e.g., indicating that they are likely to complete payment relatively quickly), the interface 115 may be configured to emphasize or highlight aspects that will improve the probability of prompt payment, such as by relocating, emphasizing, or otherwise modifying various GUI elements (e.g., increasing the prominence of a button to complete payment, and/or decreasing the prominence of a button to request a payment plan).

As additional examples, the dynamic interfaces 115 may include modifying how the interface is delivered (e.g., the type of the notification or interface), how often interface(s) 115 are provided (e.g., how often reminders are sent), modifying the content(s) of the interface(s) 115, and the like. Further, in some aspects, the evaluation system 105 (or other systems) may perform further operations based on the engagement scores. For example, the system may determine whether to escalate efforts to settle a previous request based on the user's engagement score, whether to prompt the user's healthcare provider to engage with the user (e.g., to ensure they are engaging actively in their therapy), and the like.

### Example Workflow for Generating Customized Interfaces Based on Engagement Scores Generated Using Settlement Data

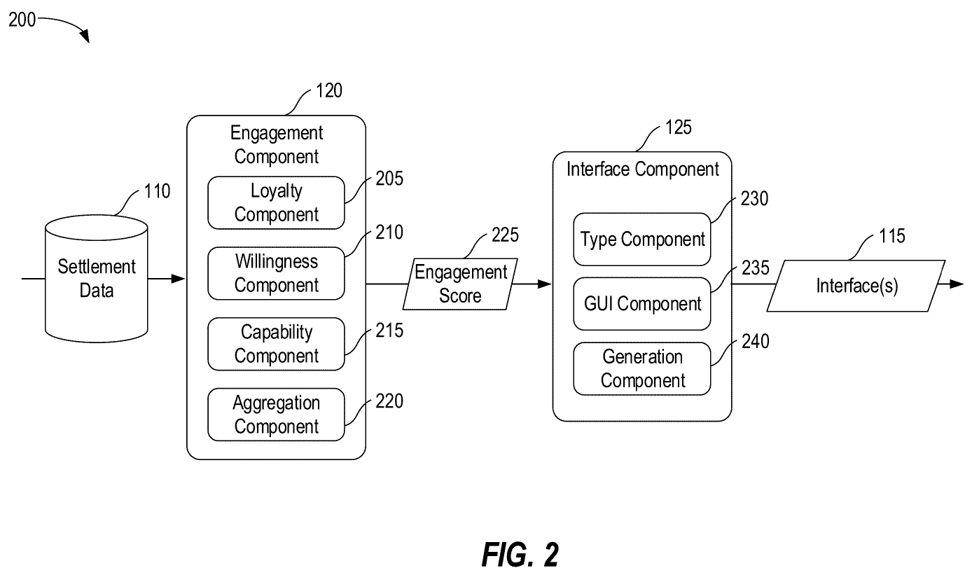

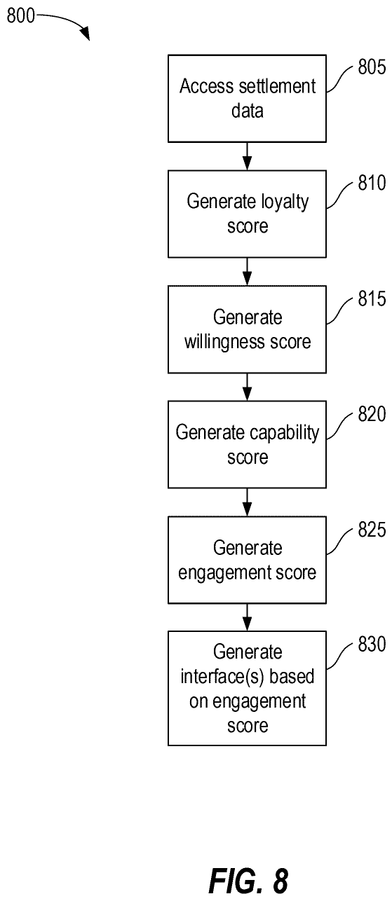

FIG. 2 depicts an example workflow 200 for generating customized interfaces based on engagement scores generated using settlement data, according to some embodiments of the present disclosure. In some embodiments, the workflow 200 is performed by an evaluation system, such as the evaluation system 105 of FIG. 1. One example method providing more detail for the workflow 200 is discussed in more detail below with reference to FIG. 8.

In the illustrated workflow 200, the settlement data 110 is accessed by the engagement component 120 to generate an engagement score 225 for a user. As discussed above, the engagement score 225 may generally indicate how engaged the user is. For example, the engagement score 225 may be a continuous value (e.g., between zero and one, inclusive) where higher scores indicate higher engagement. In some embodiments, the engagement score 225 may additionally or alternatively include categorical classifications, such as indicating whether the user has low, medium or high engagement.

In the illustrated example, the engagement component 120 comprises a variety of subcomponents, including a loyalty component 205, a willingness component 210, a capability component 215, and an aggregation component 220. Although depicted as discrete components for conceptual clarity, the operations of the illustrated components (and others not depicted) may be combined or distributed across any number and variety of components.

In the illustrated example, the loyalty component 205 may be used to generate a loyalty score for the user based on one or more components of the settlement data 110, as discussed in more detail below with reference to FIGS. 3 and/or 9. In some embodiments, the loyalty score(s) may be indicative of the loyalty of the user with respect to the entity that provides the requested item(s), such as based on evaluating information related to repeated orders and/or payments, the frequency of item requests, and the like.

In the illustrated example, the willingness component 210 may be used to generate a willingness score for the user based on one or more components of the settlement data 110, as discussed in more detail below with reference to FIGS. 4 and/or 10. In some embodiments, the willingness score(s) may be indicative of how willing the user is to pay for the medical products purchased and/or rented from the provider. For example, the willingness component 210 may evaluate information related to their behavior and preferences with respect to payments, such as the frequency of delays in payment.

In the illustrated example, the capability component 215 may be used to generate a capability score for the user based on one or more components of the settlement data 110, as discussed in more detail below with reference to FIGS. 5 and/or 11. In some embodiments, the capability score(s) may be indicative of how capable the user is of paying for the medical products purchased and/or rented from the provider. For example, the capability component 215 may evaluate information related to payment plans and/or other financial factors for the user.

In the illustrated example, the aggregation component 220 may be used to generate an aggregated engagement score 225 for the user based on one or more sub-scores, such as a loyalty score, a willingness score, a capability score, and the like, as discussed in more detail below with reference to FIGS. 6 and/or 12. In some embodiments, as discussed above, the engagement score 225 may generally indicate how engaged the user is with respect to the product or healthcare provider.

In the illustrated system 100, the engagement score 225 is accessed by the interface component 125 to generate the customized interface(s) 115 for the user. In the illustrated example, the interface component 125 comprises a variety of subcomponents, including a type component 230, a GUI component 235, and a generation component 240. Although depicted as discrete components for conceptual clarity, the operations of the illustrated components (and others not depicted) may be combined or distributed across any number and variety of components.

In some embodiments, the type component 230 and/or GUI component 235 may be used to generate an interface configuration based on the engagement score 225, while the generation component 240 may be used to generate the interface 115 itself based on the generated configuration(s), as discussed in more detail below with reference to FIGS. 7 and/or 13.

In some embodiments, the type component 230 may evaluate the engagement score 225 to select an interface and/or notification type, from a set of candidate types. For example, the notification types may include, without limitation, text messages, emails, push notifications, (automated) telephone calls, physical letters or other mailings, and the like. That is, based on the engagement score 225, the type component 230 may select the communication medium(s) used to provide the interface 115. For example, the type component 230 may determine to use more invasive notification types (e.g., push notifications or an automated telephone call) when the engagement score 225 is low (e.g., to improve the probability that the user notices and pays attention to the interface 115) while using less invasive types (e.g., an email or physical mailing) when the engagement score 225 is high (e.g., because the user is already likely to pay attention to the interface 115).

In some embodiments, the type component 230 may additionally or alternatively determine other configuration characteristics, such as how often to provide a new interface 115 to the user (e.g., daily, weekly, monthly, and the like). In some embodiments, the type component 230 may generally be used to control the delivery of the interface 115 (e.g., how it is delivered, how often it is delivered, and the like), while the GUI component 235 may be used to control the content and impression caused by the interface 115 (e.g., what the interface 115 includes or excludes, how the interface 115 looks, and the like).

In some embodiments, the GUI component 235 may evaluate the engagement score 225 to configure the particular configuration and/or arrangement of components (e.g., graphical elements of the GUI) for the interface 115. For example, in some embodiments, the GUI component 235 may determine whether to include or exclude one or more GUI elements based on the score. As one example, if the engagement score 225 is low (e.g., below a threshold), the GUI component 235 may determine to include components intended to increase engagement and/or probability of completing the order (e.g., adding a link to request payment plan options). As another example, if the engagement score 225 is high (e.g., greater than a threshold), the GUI component 235 may determine to exclude the payment plan elements, and to include elements to facilitate immediate (or at least more rapid) completion, such as a “pay now” button.

In some embodiments, the GUI component 235 may additionally or alternatively configure the particular arrangement of components on the GUI. For example, the GUI component 235 may adjust the positioning of elements (e.g., to emphasize some elements and deemphasize others), the size of the elements, the colors or highlighting of the elements, and the like.

In the illustrated example, the generation component 240 can use the interface configuration(s), generated by the type component 230 and/or the GUI component 235, to generate and deliver interface(s) 115 (e.g., to user devices). For example, as discussed above, the generation component 240 may generate an interface 115 (e.g., a GUI) containing the particular arrangement of elements specified by the GUI component 235, and then deliver this generated interface 115 using the indicated delivery methodology and frequency.

In these ways, as discussed above, the evaluation system can substantially improve operations. For example, by using dynamically selected delivery methods (based on the engagement scores 225), the evaluation system can improve the probability that the user will engage with a given notification or interface 115, thereby reducing the resources consumed to provide further reminders. These improvements may include, for example, reducing traffic over one or more wired or wireless networks (e.g., thereby reducing congestion and improving network stability and throughput), reducing physical resources used to mail physical mailers (e.g., reducing waste of paper products themselves, as well as electricity and/or fossil fuels used to transport the materials), and the like. Further, the computational expense of the evaluation system itself is reduced. For example, because the interfaces 115 are more likely to achieve the desired result (e.g., engagement with the user), the evaluation system may expend fewer resources performing subsequent evaluations and/or generating subsequent interfaces (e.g., for subsequent reminders due to ineffective initial notifications).

### Example Workflow for Generating Loyalty Scores to Facilitate Customized Interfaces Based on Settlement Data

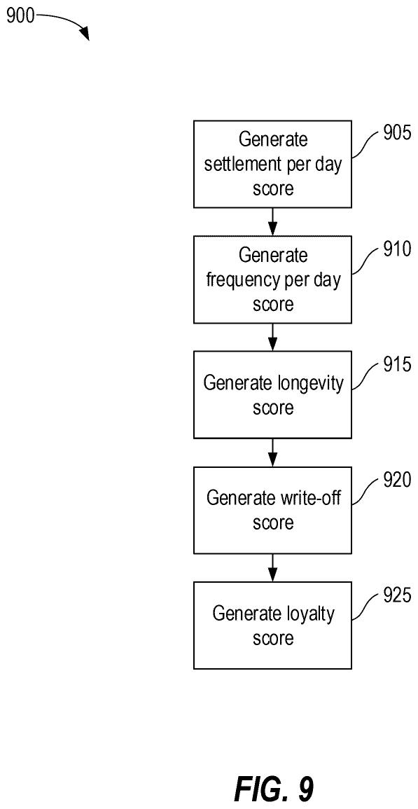

FIG. 3 depicts an example workflow 300 for generating loyalty scores to facilitate customized interfaces based on settlement data, according to some embodiments of the present disclosure. In some embodiments, the workflow 300 may be performed by an evaluation system, such as the evaluation system 105 of FIG. 1. For example, the workflow 300 may be performed by an engagement component (e.g., the engagement component 120 of FIGS. 1-2) of an evaluation system, and/or by a loyalty component of an engagement component (e.g., the loyalty component 205 of FIG. 2). One example method providing more detail for the workflow 300 is discussed in more detail below with reference to FIG. 9.

In the illustrated workflow 300, settlement data 110 is accessed by an input component 305 to generate a set of initial scores or values, including a settlement per day score 310, a frequency per day score 315, a longevity score 320, and a write-off score 325. Although four discrete sub-scores are depicted for conceptual clarity, in some aspects, the evaluation system may use more or fewer of these initial scores to generate the loyalty score 335.

In some embodiments, the settlement per day score 310 (also referred to in some aspects as a “revenue per day” or “per day revenue”) may correspond to the number and/or amount of settlements (e.g., the number of paid invoices and/or total monetary value of the paid invoices) per day during the user's interactions with the evaluation system. For example, in some aspects, the settlement per day score 310 is defined using Equation 1 below, where spd is the settlement per day score 310, tc is the total number of days that the user has been a customer or user of the system (e.g., since the beginning of therapy, or since their first purchase or support request), pt is the total amount of all payments that have been made by the user (e.g., the total dollar amount across all requests), tdd is the total delayed days (e.g., the total number of days that the user has delayed payment past a due date), and φ is a hyperparameter defining the delay penalty (e.g., with a value of 0.01). For example, as delayed payments are a factor used to penalize the settlement per day score 310 in Equation 1, a value of φ=0.01 means the delay penalty is 1% of the total payment amount.

$$spd = ( \frac{1}{{tc}^{2}} ) * ( ( pt * ( tc - tdd ) ) + ( pt * tdd * ( 1 - φ ) ) ) \qquad ( 1 )$$

In some embodiments, the frequency per day score 315 (also referred to in some aspects as a “purchase frequency” or “purchase frequency per day”) may correspond to the frequency or number of times the user has requested (e.g., ordered) support (e.g., consumables or new equipment) in conjunction with their therapy. For example, in some aspects, the frequency per day score 315 is defined using Equation 2 below, where fpd is the frequency per day score 315, tc is the total number of days that the user has been a customer or user of the system (e.g., since the beginning of therapy, or since their first purchase or support request), ti is the total number of invoices (e.g., the number of requests or orders) from the user, tdd is the total delayed days (e.g., the total number of days that the user has delayed payment past a due date), and φ is a hyperparameter defining the delay penalty (e.g., with a value of 0.01). For example, as delayed payments may also be a factor used to penalize the frequency per day score 315 in Equation 2, a value of φ=0.01 means the delay penalty is 1% of the total payment amount.

$$fpd = ( \frac{1}{{tc}^{2}} ) * ( ( ti * ( tc - tdd ) ) + ( ti * tdd * ( 1 - φ ) ) ) \qquad ( 2 )$$

In some embodiments, the longevity score 320 (also referred to in some aspects as a “patient lifespan” or “user lifespan”) may correspond to the length of time that the user has been a user or patient of the therapy (e.g., since therapy began, or since their first order). For example, in some aspects, the longevity score 320 is defined using Equation 3 below, where l is the longevity score 320, tc is the total number of days that the user has been a customer or user of the system (e.g., since the beginning of therapy, or since their first purchase or support request), and n is the total patient or user count (e.g., the total number of patients or users that are engaged with the evaluation system and/or with the therapy).

$$l = ( \frac{tc}{\frac{1}{n} {\sum }_{i = 1}^{n} tc} ) \qquad ( 3 )$$

In some embodiments, the write-off score 325 (also referred to in some aspects as a “write-off ratio”) may correspond to the amount of value that was owed to the provider by the patient but that has been written off by the provider (e.g., the dollar amount that has been forgiven) rather than collected. For example, in some aspects, the write-off score 325 is defined using Equation 4 below, where wor is the write-off score 325, wt is the total amount (e.g., the dollar amount) that the user owed but that has been written off, and pt is the total amount of all payments that have been made by the user (e.g., the total dollar amount actually paid, across all requests).

$$wor = ( \frac{wt}{pt} ) \qquad ( 4 )$$

In the illustrated example, the settlement per day score 310, frequency per day score 315, longevity score 320, and write-off score 325 are then accessed by a scoring component 330, which aggregates these sub-scores to generate the loyalty score 335 for the user. Generally, the scoring component 330 may use a variety of formulations to generate the loyalty score 335. For example, in some embodiments, the scoring component 330 may compute a weighted sum of the component scores, such as using Equation 5 below, where ls is the user's loyalty score 335, and α, β, γ, and δ are hyperparameter weights (which may have the same value or may have different values).

$$ls = ( α * spd ) + ( β * fpd ) + ( γ * l ) - ( δ * wor ) \qquad ( 5 )$$

As discussed above, the loyalty score 335 may be one factor used to evaluate or quantify the engagement of the user. This engagement score can then be used for a variety of purposes, including customizing dynamic interfaces (e.g., GUIs) based on the user's engagement, as discussed above and in more detail below.

### Example Workflow for Generating Willingness Scores to Facilitate Customized Interfaces Based on Settlement Data

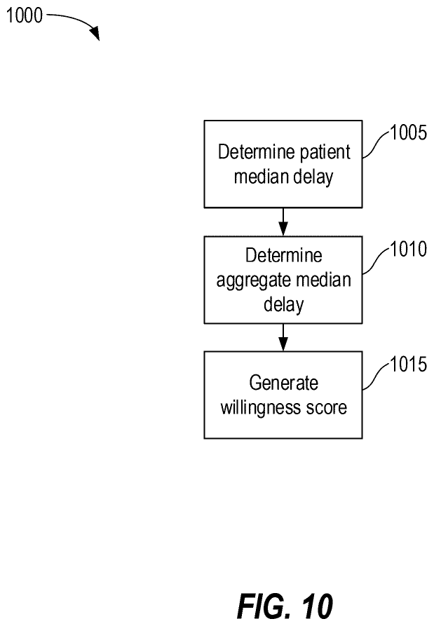

FIG. 4 depicts an example workflow 400 for generating willingness scores to facilitate customized interfaces based on settlement data, according to some embodiments of the present disclosure. In some embodiments, the workflow 400 may be performed by an evaluation system, such as the evaluation system 105 of FIG. 1. For example, the workflow 400 may be performed by an engagement component (e.g., the engagement component 120 of FIGS. 1-2) of an evaluation system, and/or by a willingness component of an engagement component (e.g., the willingness component 210 of FIG. 2). One example method providing more detail for the workflow 400 is discussed in more detail below with reference to FIG. 10.

In the illustrated workflow 400, settlement data 110 is accessed by an input component 405 (which may correspond to the input component 305 of FIG. 3, or may be a discrete component) to generate a set of initial scores or values, including a patient delay 410 and an aggregate delay 415. Although two discrete sub-scores are depicted for conceptual clarity, in some aspects, the evaluation system may use more or fewer of these initial scores to generate the willingness score 435.

In some embodiments, the patient delay 410 (also referred to in some aspects as a “median delay days”) may correspond to the number of delay days (e.g., days when payment was due but not-yet paid by the user) over one or more prior requests for the user. For example, the patient delay 410 may correspond to the total number of delay days from the user (e.g., since the first request, over the last N requests (where N is a hyperparameter), and/or over the last M months or other window of time (where M is a hyperparameter)). As another example, the patient delay 410 may indicate the median, average, maximum, and/or minimum number of delay days over all prior requests from the user, over the last N requests (where N is a hyperparameter), and/or over the last M months or other period of time (where M is a hyperparameter).

In some embodiments, the aggregate delay 415 (also referred to in some aspects as a “maximum delay days”) may correspond to the number of delay days (e.g., days when payment was due but not-yet paid by a user) over one or more prior requests across all users or patients of the system. For example, the aggregate delay 415 may correspond to the largest patient delay across all of the users. For example, a patient delay may be determined for each user as discussed above, and the evaluation system may define the aggregate delay 415 as the largest of these individual patient delays (e.g., the largest median number of delay days across all patients over the last N orders from each patient).

In the illustrated example, the patient delay 410 and aggregate delay 415 are then accessed by a scoring component 430 (which may correspond to the scoring component 330 of FIG. 3, or may be a discrete component), which aggregates these sub-scores to generate the willingness score 435 for the user. Generally, the scoring component 430 may use a variety of formulations to generate the willingness score 435. For example, in some embodiments, the scoring component 430 may use Equation 6 below, where ws is the user's willingness score 435, mddₚₜ is the patient delay 410, and mddₘₐₓ the aggregate delay 415.

$$ws = ( 1 - ( \frac{{mdd}_{pt}}{{mdd}_{max}} ) ) \qquad ( 6 )$$

In some aspects, the willingness score 435 ranges between zero and one, where higher scores indicate a greater user willingness. As discussed above, the willingness score 435 may be one factor used to evaluate or quantify the engagement of the user. This engagement score can then be used for a variety of purposes, including customizing dynamic interfaces (e.g., GUIs) based on the user's engagement, as discussed above and in more detail below.

### Example Workflow for Generating Capability Scores to Facilitate Customized Interfaces Based on Settlement Data

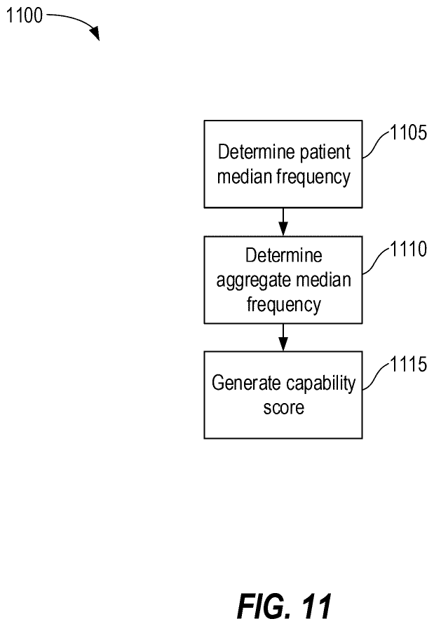

FIG. 5 depicts an example workflow 500 for generating capability scores to facilitate customized interfaces based on settlement data, according to some embodiments of the present disclosure. In some embodiments, the workflow 500 may be performed by an evaluation system, such as the evaluation system 105 of FIG. 1. For example, the workflow 500 may be performed by an engagement component (e.g., the engagement component 120 of FIGS. 1-2) of an evaluation system, and/or by a capability component of an engagement component (e.g., the capability component 215 of FIG. 2). One example method providing more detail for the workflow 500 is discussed in more detail below with reference to FIG. 11.

In the illustrated workflow 500, settlement data 110 is accessed by an input component 505 (which may correspond to the input component 305 of FIG. 3 and/or the input component 405 of FIG. 4, or may be a discrete component) to generate a set of initial scores or values, including a patient frequency 510 and an aggregate frequency 515. Although two discrete sub-scores are depicted for conceptual clarity, in some aspects, the evaluation system may use more or fewer of these initial scores to generate the capability score 535.

In some embodiments, the patient frequency 510 may correspond to the median payment frequency of the user over the N most recent purchases or orders of the user. For example, the patient frequency 510 may indicate the median payment frequency or number of payments selected and/or used by the user for their previous N purchases (e.g., whether they chose to make a single payment to settle the invoice, or to pay it over time, such as over six payments, over ten payments, and the like).

In some embodiments, the aggregate frequency 515 may correspond to the median payment frequency of all users over their N most recent purchases or orders. For example, the aggregate frequency 515 may indicate the median payment frequency or number of payments selected and/or used across all users for the previous N purchases.

In the illustrated example, the patient frequency 510 and aggregate frequency 515 are then accessed by a scoring component 530 (which may correspond to the scoring component 330 of FIG. 3 and/or the scoring component 430 of FIG. 4, or may be a discrete component), which aggregates these sub-scores to generate the capability score 535 for the user. Generally, the scoring component 530 may use a variety of formulations to generate the capability score 535. For example, in some embodiments, the scoring component 530 may use Equation 7 below, where cs is the user's capability score 535, mpfₚₜ is the patient frequency 510, and mpfₘₐₓ the aggregate frequency 515.

$$cs = ( 1 - ( \frac{{mpf}_{pt}}{{mpf}_{max}} ) ) \qquad ( 7 )$$

In some aspects, the capability score 535 ranges between zero and one, where higher scores indicate a greater user capacity. As discussed above, the capability score 535 may be one factor used to evaluate or quantify the engagement of the user. This engagement score can then be used for a variety of purposes, including customizing dynamic interfaces (e.g., GUIs) based on the user's engagement, as discussed above and in more detail below.

### Example Workflow for Generating Engagement Scores to Facilitate Customized Interfaces Based on Settlement Data

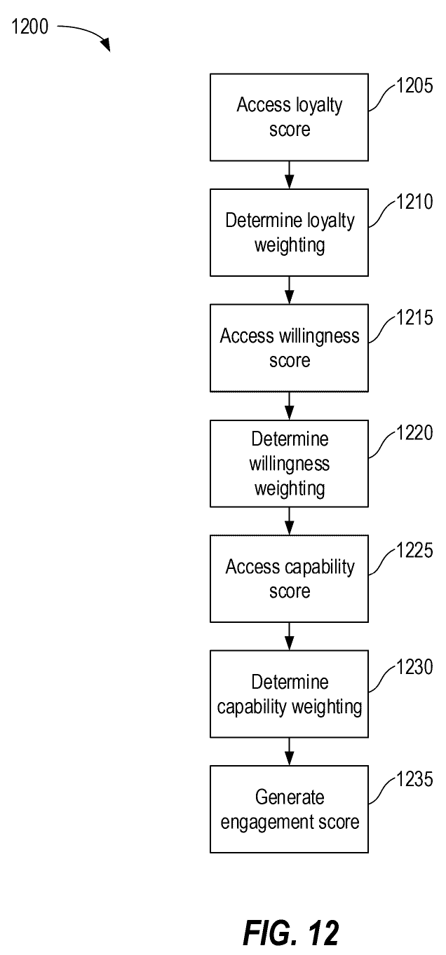

FIG. 6 depicts an example workflow 600 for generating engagement scores to facilitate customized interfaces based on settlement data, according to some embodiments of the present disclosure. In some embodiments, the workflow 600 may be performed by an evaluation system, such as the evaluation system 105 of FIG. 1. For example, the workflow 600 may be performed by an engagement component (e.g., the engagement component 120 of FIGS. 1-2) of an evaluation system, and/or by an aggregation component of an engagement component (e.g., the aggregation component 220 of FIG. 2). One example method providing more detail for the workflow 600 is discussed in more detail below with reference to FIG. 12.

In the illustrated example, the loyalty score 335 (e.g., generated using the workflow 300 of FIG. 3), the willingness score 435 (e.g., generated using the workflow 400 of FIG. 4), and the capability score 535 (e.g., generated using the workflow 500 of FIG. 5) to generate the engagement score 225 for the user. Although three discrete sub-scores are depicted for conceptual clarity, in some aspects, the evaluation system may use more or fewer of these initial scores to generate the overall engagement score 225.

Generally, the aggregation component 220 may use a variety of formulations to generate the engagement score 225. For example, in some embodiments, the aggregation component 220 may use Equation 8 below, where es is the user's engagement score 225, ls is the user's loyalty score 335, ws is the user's willingness score 435, cs is the user's capability score 535, and α, β, and γ are hyperparameter weights (which may have the same value or may have different values).

$$es = ( α * ls ) + ( β * ws ) + ( γ * cs ) \qquad ( 8 )$$

As discussed above, the engagement score 225 may then be used for a variety of purposes, including customizing dynamic interfaces (e.g., GUIs) based on the user's engagement, as discussed above and in more detail below.

### Example Workflow for Generating Customized Interfaces Based on Engagement Scores

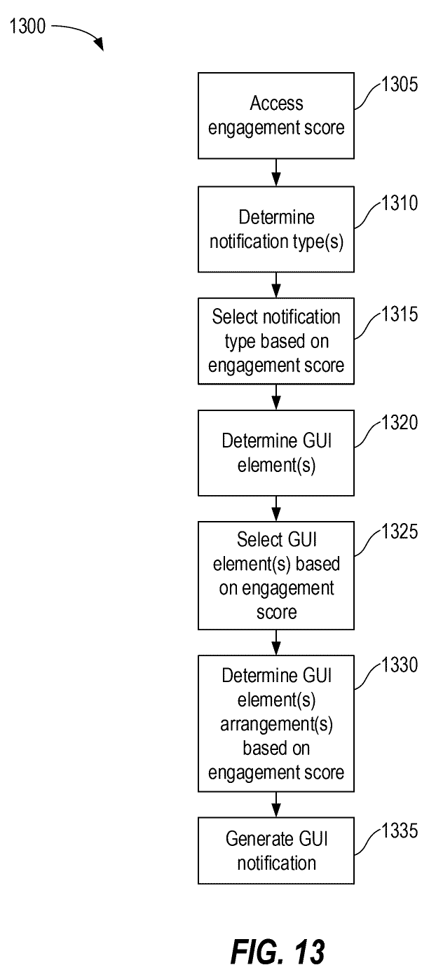

FIG. 7 depicts an example workflow 700 for generating customized interfaces based on engagement scores, according to some embodiments of the present disclosure. In some embodiments, the workflow 700 may be performed by an evaluation system, such as the evaluation system 105 of FIG. 1. For example, the workflow 700 may be performed by an interface component (e.g., the interface component 125 of FIGS. 1-2) of an evaluation system. One example method providing more detail for the workflow 700 is discussed in more detail below with reference to FIG. 13.

In the illustrated example, the engagement score 225 for the user (e.g., generated using the workflow 600 of FIG. 6) is used to generate a dynamic and customized interface 115 (e.g., a GUI) for the user. In the illustrated workflow 700, the engagement score 225 is accessed by several components, including a type component 230 and a GUI component 235. Although two discrete components are depicted for conceptual clarity, in some aspects, the evaluation system may use more or fewer components to generate the interface configuration.

In the depicted example, the type component 230 evaluates the engagement score 225 to generate a notification type 705 (also referred to as an interface type in some aspects). In some embodiments, the type component 230 selects the notification type 705 from a set or candidate notification types. For example, the type component 230 may determine the various notification types that are available to interact with or contact the user, and may select one of these types based on the engagement score 225. Generally, the notification types may include a wide variety of means for the communication, including text message, automated phone call, email, push notification (e.g., via an application executing on the user's personal device), physical mailing, and the like.

In some embodiments, the type component 230 selects the notification type to balance the invasiveness or intrusiveness of the communication with the probability that the user will engage with the content (e.g., based on the engagement score 225). For example, the type component 230 may select a more intrusive notification type 705 if the user has a low engagement score 225 (e.g., using an automated phone call rather than an email) to account for the probability that the user will ignore the message (e.g., due to their low engagement). In some aspects, rather than selecting one notification type 705, the type component 230 may determine how many different types to use (e.g., using only an email for users with high engagement scores 225, while using emails, text messages, and push notifications for users having low engagement scores 225). Generally, the type component 230 may use a variety of techniques to select the notification type 705. For example, in some aspects, the type component 230 may use a threshold-based approach where the specific type(s) used may be defined based on whether the engagement score 225 satisfies one or more threshold(s) applicable to each notification type 705.

In some embodiments, in addition to or instead of selecting the notification type 705, the type component 230 may select other attributes of the messaging, such as the delay before sending one or more notifications, the delay or frequency between notifications, and the like. For example, if a first interface is automatically provided to the user after completing a request, the type component 230 may determine how long to wait before generating and sending another interface as a reminder (e.g., based on the engagement score 225). For example, the type component 230 may delay longer before sending a reminder if the user's engagement score 225 is high. As another example, the type component 230 may determine the number of reminders to use. For example, the type component 230 may determine to send fewer reminders to users with high engagement scores 225, as these users are likely to respond quickly regardless. Alternatively, the system may determine to send additional reminders to users with high engagement scores 225 (e.g., before escalating the efforts, such as by contacting a collections agency), as these users may be more likely to respond (eventually) to ordinary reminders.

In these ways, the type component 230 can dynamically select not only the means of communication (e.g., which communication medium to use), but also the frequency and number of such communications, based on the engagement score 225. As discussed above, this may improve (e.g., reduce) the use of computational resources. For example, the type component 230 may use less intrusive notification types 705 for high engagement scores 225. As these less intrusive types often involve less computational expense (e.g., a simple text generally consumes less network bandwidth than an audio call), the evaluation system is therefore able to reduce the network burden and computational expense of generating and transmitting dynamic interfaces 115 to users.

Similarly, as the type component 230 may send fewer notifications for some users (as compared to conventional systems using a fixed reminder schedule), the type component 230 can further reduce the computational expense and network burden of providing dynamic interfaces 115.

In the depicted example, the GUI component 235 evaluates the engagement score 225 to generate a set of GUI elements 710. In some embodiments, the GUI component 235 selects a set of GUI elements 710 for inclusion, from a set or candidate elements. For example, the GUI component 235 may identify the various GUI elements that can be included in a dynamic interface 115, and may select one or more of these elements for inclusion for the specific user based on the engagement score 225. Generally, the GUI elements may include a wide variety of characteristics, including elements for receiving input from the user, elements for providing information to the user, elements for improving the look-and-feel of the interface 115, and the like.

As one example, in some embodiments, the GUI component 235 may determine whether to include options such as “pay now” or “view payment plans” based on the engagement score 225. For example, if the user has a high engagement score 225, the GUI component 235 may infer that the user is likely to complete payment rapidly, and may therefore determine that there is no need to include the “request a payment plan” button in the set of GUI elements 710 for the user. As another example, if the user has a low engagement score 225, the GUI component 235 may determine to include the “payment plans” button, and may further determine that other elements may be useful, such as a “tips and tricks” element of the GUI. Generally, the GUI component 235 may use a variety of techniques to select the set of GUI elements 710. For example, in some aspects, the GUI component 235 may use a threshold-based approach where the specific elements(s) to be included may be defined based on whether the engagement score 225 satisfies one or more threshold(s) applicable to each GUI element 710.

In some embodiments, the GUI component 235 may additionally or alternatively generate or select other characteristics of the GUI components 235. For example, in some embodiments, the GUI component 235 may select the size of one or more GUI elements 710, the color and/or shape of one or more GUI elements, the positioning of one or more GUI elements 710 on the interface 115, and the like.

In these ways, the GUI component 235 may dynamically emphasize (or deemphasize) the elements based on the score. As one example, to emphasize a given element (e.g., the “deferred settlement” element to request an extension on the payment deadline and/or a payment plan), the GUI component 235 may determine to change the color of the element (e.g., highlighting it using a brighter color and/or adding a drop shadow around the element), change the size of the element (e.g., increasing the size relative to other similar elements), move the element to a more prominent location (e.g., near to the top of the interface 115 so the user need not scroll to see it, or nearer to other relevant elements such as the total price element), and the like.

In these ways, the GUI component 235 can dynamically define the arrangement and contents of the interface 115 based on the engagement score 225. As discussed above, this may improve (e.g., reduce) the use of computational resources. For example, the GUI component 235 may use less intrusive notification types 705 for high engagement scores 225. As these less intrusive types often involve less computational expense (e.g., a simple text generally consumes less network bandwidth than an audio call), the evaluation system is therefore able to reduce the network burden and computational expense of generating and transmitting dynamic interfaces 115 to users.

Similarly, the GUI component 235 may dynamically generate more interactive interfaces 115 that increase the probability that the specific user will interact with or respond to the message, fewer notifications may be sent (as compared to conventional systems using a fixed GUI). In this way, the GUI component 235 can further reduce the computational expense and network burden of providing the dynamic interfaces 115. Further, by dynamically selecting the GUI elements 710 to be included, the GUI component 235 may enable use of fewer elements for some interfaces 115, thereby reducing the size of the interface (e.g., the number of memory bytes consumed by the interface). This reduced size can thereby result in reduced storage expense, as well as reduced burden on the network (e.g., reduced bandwidth consumed to transmit the elements).

In the illustrated example, the notification type 705 and GUI elements 710 are accessed by the generation component 240. The generation component 240 may generally use these inputs to generate the interface 115. Although the illustrated example depicts the generation component 240 evaluating two components (the notification type 705 and the GUI elements 710) to generate the interface 115, in some embodiments, the generation component 240 may evaluate other inputs as well. Generally, the generation component 240 may generate the interface 115 based on any number of characteristics provided by any number of components. In some embodiments, the characteristics of the interface may be collectively referred to as an “interface configuration.” That is, aspects such as the notification type 705, set of included GUI elements 710, notification frequency or delay, GUI element sizing and positioning, and the like may all be referred to as the interface configuration for the interface 115.

In some embodiments, after generating the interface 115, the generation component 240 (or another component) can transmit or otherwise provide the generated interface 115 in accordance with the generated interface configuration. For example, the generation component 240 may transmit the interface 115 according to the generated schedule, using the selected type, including the selected elements, and the like.

In these ways, the evaluation system can significantly reduce computational expense while simultaneously improving the probability of user engagement and interaction with the interfaces 115.

### Example Method for Generating Customized Interfaces Based on Engagement Scores Generated Using Settlement Data

FIG. 8 is a flow diagram depicting an example method 800 for generating customized interfaces based on engagement scores generated using settlement data, according to some embodiments of the present disclosure. In some embodiments, the method 800 may be performed by an evaluation system, such as the evaluation system 105 of FIG. 1. In some embodiments, the method 800 provides additional detail for the workflow 200 discussed above with reference to FIG. 2.

At block 805, the evaluation system accesses settlement data for a given user (e.g., the settlement data 110 of FIGS. 1-5). For example, as discussed above, the settlement data may generally include information for a set of prior requests, such as the date when the request was received or completed, the amount (e.g., the dollar amount) of the request, the settlement date when the request was settled (e.g., when the user paid the invoice), and the like.

At block 810, the evaluation system generates a loyalty score (e.g., the loyalty score 335 of FIG. 3) for the user based on the settlement data. For example, as discussed above with reference to FIG. 3, the evaluation system may generate loyalty sub-scores such as a settlement per day score (e.g., the settlement per day score 310 of FIG. 3), a frequency per day score (e.g., the frequency per day score 315 of FIG. 3), a longevity score (e.g., the longevity score 320 of FIG. 3), and a write-off score (e.g., the write-off score 325 of FIG. 3). These scores may then be combined, as discussed above, to generate the overall loyalty score for the user. One example method for generating the loyalty score is discussed in more detail below with reference to FIG. 9.

At block 815, the evaluation system generates a willingness score (e.g., the willingness score 435 of FIG. 4) for the user based on the settlement data. For example, as discussed above with reference to FIG. 4, the evaluation system may generate willingness sub-scores or values such as a patient delay measure (e.g., the patient delay 410 of FIG. 4) and/or an aggregate delay measure (e.g., the aggregate delay 415 of FIG. 4). These measures may then be combined, as discussed above, to generate the overall willingness score for the user. One example method for generating the willingness score is discussed in more detail below with reference to FIG. 10.

At block 820, the evaluation system generates a capability score (e.g., the capability score 535 of FIG. 5) for the user based on the settlement data. For example, as discussed above with reference to FIG. 5, the evaluation system may generate capability sub-scores or values such as a patient frequency measure (e.g., the patient frequency 510 of FIG. 5) and/or an aggregate frequency measure (e.g., the aggregate frequency 515 of FIG. 5). These measures may then be combined, as discussed above, to generate the overall capability score for the user. One example method for generating the capability score is discussed in more detail below with reference to FIG. 11.

Although the illustrated example depicts generating the loyalty score, willingness score, and capability score sequentially for conceptual clarity, in some embodiments, some or all of these scores may be generated entirely or partially in parallel, or in orders differing from the depicted sequence.

At block 825, the evaluation system generates an engagement score (e.g., the engagement score 225 of FIG. 6) for the user based on the loyalty score, willingness score, and/or capability score. For example, as discussed above with reference to FIG. 6, the evaluation system may aggregate these individual scores (e.g., using a weighted average) to generate the overall engagement score for the user. One example method for generating the engagement score is discussed in more detail below with reference to FIG. 12.

At block 830, the evaluation system generates one or more dynamic and customized interfaces (e.g., the interface 115 of FIG. 7) based on the user's engagement score. For example, as discussed above, the evaluation system may dynamically generate, select, or determine interface configurations including the type(s) of interfaces to use, the contents (e.g., GUI element(s)) to include, the timing (e.g., frequency) of interfaces to send, the arrangement of elements within the interface, and the like. One example method for generating the interface(s) score is discussed in more detail below with reference to FIG. 13.

In these ways, as discussed above, the evaluation system may substantially reduce the computational expense of generating and providing such interfaces while also improving the probability that the user will engage with the interfaces in a timely manner.

### Example Method for Generating Loyalty Scores to Facilitate Customized Interfaces Based on Settlement Data

FIG. 9 is a flow diagram depicting an example method 900 for generating loyalty scores to facilitate customized interfaces based on settlement data, according to some embodiments of the present disclosure. In some embodiments, the method 900 may be performed by an evaluation system, such as the evaluation system 105 of FIG. 1. For example, the method 900 may be performed by an engagement component (e.g., the engagement component 120 of FIGS. 1-2) of an evaluation system, and/or by a loyalty component of an engagement component (e.g., the loyalty component 205 of FIG. 2). In some embodiments, the method 900 provides additional detail for the workflow 300 discussed above with reference to FIG. 3. In some aspects, the method 900 provides additional detail for block 810 of FIG. 8.

At block 905, the evaluation system generates a settlement per day score (e.g., the settlement per day score 310 of FIG. 3) based on the user's settlement data. For example, as discussed above, the evaluation system may use various formulations such as Equation 1 to define the settlement per day score of the user.

At block 910, the evaluation system generates a frequency per day score (e.g., the frequency per day score 315 of FIG. 3) based on the user's settlement data. For example, as discussed above, the evaluation system may use various formulations such as Equation 2 to define the frequency per day score of the user.

At block 915, the evaluation system generates a longevity score (e.g., the longevity score 320 of FIG. 3) based on the user's settlement data. For example, as discussed above, the evaluation system may use various formulations such as Equation 3 to define the longevity score of the user.

At block 920, the evaluation system generates a write-off score (e.g., the write-off score 325 of FIG. 3) based on the user's settlement data. For example, as discussed above, the evaluation system may use various formulations such as Equation 4 to define the write-off score of the user.

At block 925, the evaluation system generates a loyalty score (e.g., the loyalty score 335 of FIG. 3) based on the user's settlement per day score, frequency per day score, longevity score, and/or write-off score. For example, as discussed above, the evaluation system may use various formulations such as Equation 5 to define the loyalty score of the user.

### Example Method for Generating Willingness Scores to Facilitate Customized Interfaces Based on Settlement Data

FIG. 10 is a flow diagram depicting an example method 1000 for generating willingness scores to facilitate customized interfaces based on settlement data, according to some embodiments of the present disclosure. In some embodiments, the method 1000 may be performed by an evaluation system, such as the evaluation system 105 of FIG. 1. For example, the method 1000 may be performed by an engagement component (e.g., the engagement component 120 of FIGS. 1-2) of an evaluation system, and/or by a willingness component of an engagement component (e.g., the willingness component 210 of FIG. 2). In some embodiments, the method 1000 provides additional detail for the workflow 400 discussed above with reference to FIG. 4. In some aspects, the method 1000 provides additional detail for block 815 of FIG. 8.

At block 1005, the evaluation system determines a patient median delay (e.g., the patient delay 410 of FIG. 4) based on the user's settlement data. For example, as discussed above, the evaluation system may determine the median number of days that the user has delayed payment for one or more prior requests.

At block 1010, the evaluation system determines an aggregate median delay (e.g., the aggregate delay 415 of FIG. 4) based on the user's settlement data. For example, as discussed above, the evaluation system may determine, for one or more other users, the median number of days that each other user has delayed payment for one or more prior requests. The evaluation system may then define the aggregate median delay as the largest (e.g., maximum) of these user-specific median delays.

At block 1015, the evaluation system generates a willingness score (e.g., the willingness score 435 of FIG. 4) based on the median patient delay and/or the median aggregate delay, as discussed above. For example, as discussed above, the evaluation system may use various formulations such as Equation 6 to define the willingness score of the user.

### Example Method for Generating Capability Scores to Facilitate Customized Interfaces Based on Settlement Data

FIG. 11 is a flow diagram depicting an example method 1100 for generating capability scores to facilitate customized interfaces based on settlement data, according to some embodiments of the present disclosure. In some embodiments, the method 1100 may be performed by an evaluation system, such as the evaluation system 105 of FIG. 1. For example, the method 1100 may be performed by an engagement component (e.g., the engagement component 120 of FIGS. 1-2) of an evaluation system, and/or by a capability component of an engagement component (e.g., the capability component 215 of FIG. 2). In some embodiments, the method 1100 provides additional detail for the workflow 500 discussed above with reference to FIG. 5. In some aspects, the method 1100 provides additional detail for block 820 of FIG. 8.

At block 1105, the evaluation system determines a patient median frequency (e.g., the patient frequency 510 of FIG. 5) based on the user's settlement data. For example, as discussed above, the evaluation system may determine the median payment frequency of the given user over one or more prior requests.

At block 1010, the evaluation system determines an aggregate median frequency (e.g., the aggregate frequency 515 of FIG. 5) based on the user's settlement data. For example, as discussed above, the evaluation system may determine the median payment frequency of a larger set of users (e.g., all users) over one or more prior requests.

At block 1015, the evaluation system generates a capability score (e.g., the capability score 535 of FIG. 5) based on the median patient frequency and/or the median aggregate frequency, as discussed above. For example, as discussed above, the evaluation system may use various formulations such as Equation 7 to define the capability score of the user.

### Example Method for Generating Engagement Scores to Facilitate Customized Interfaces Based on Settlement Data

FIG. 12 is a flow diagram depicting an example method 1200 for generating engagement scores to facilitate customized interfaces based on settlement data, according to some embodiments of the present disclosure. In some embodiments, the method 1200 may be performed by an evaluation system, such as the evaluation system 105 of FIG. 1. For example, the method 1200 may be performed by an engagement component (e.g., the engagement component 120 of FIGS. 1-2) of an evaluation system, and/or by an aggregation component of an engagement component (e.g., the aggregation component 220 of FIG. 2). In some embodiments, the method 1200 provides additional detail for the workflow 600 discussed above with reference to FIG. 6. In some aspects, the method 1200 provides additional detail for block 825 of FIG. 8.

At block 1205, the evaluation system accesses a loyalty score for the user. For example, as discussed above with reference to FIGS. 3, 8, and/or 9, the loyalty score may be generated based on various aspects of the user's settlement data to reflect or quantify the loyalty of the user with respect to their provider (e.g., in the context of their respiratory or other therapy).

At block 1210, the evaluation system determines a loyalty weighting for the user and/or score. For example, as discussed above, the evaluation system may use dynamic (e.g., differing) or matching weights for each component of the engagement score, depending on the particular implementation.

At block 1215, the evaluation system accesses a willingness score for the user. For example, as discussed above with reference to FIGS. 4, 8, and/or 10, the willingness score may be generated based on various aspects of the user's settlement data to reflect or quantify the willingness of the user to request items and/or complete payment for such items from their provider (e.g., in the context of their respiratory or other therapy).

At block 1220, the evaluation system determines a willingness weighting for the user and/or score. For example, as discussed above, the evaluation system may use dynamic (e.g., differing) or matching weights for each component of the engagement score, depending on the particular implementation.

At block 1225, the evaluation system accesses a capability score for the user. For example, as discussed above with reference to FIGS. 5, 8, and/or 11, the capability score may be generated based on various aspects of the user's settlement data to reflect or quantify the capability of the user to request items and/or complete payment for such items from their provider (e.g., in the context of their respiratory or other therapy).

At block 1230, the evaluation system determines a capability weighting for the user and/or score. For example, as discussed above, the evaluation system may use dynamic (e.g., differing) or matching weights for each component of the engagement score, depending on the particular implementation.

At block 1235, the evaluation system generates an engagement score for the user based on the loyalty score, the loyalty weighting, the willingness score, the willingness weighting, the capability score, and/or the capability weighting. For example, as discussed above with reference to FIG. 6, the evaluation system may use various formulations such as Equation 8 to define the engagement score of the user.

### Example Method for Generating Customized Interfaces Based on Engagement Scores

FIG. 13 is a flow diagram depicting an example method 1300 for generating customized interfaces based on engagement scores, according to some embodiments of the present disclosure. In some embodiments, the method 1300 may be performed by an evaluation system, such as the evaluation system 105 of FIG. 1. For example, the method 1300 may be performed by an interface component (e.g., the interface component 125 of FIGS. 1-2) of an evaluation system. In some embodiments, the method 1300 provides additional detail for the workflow 700 discussed above with reference to FIG. 7. In some aspects, the method 1300 provides additional detail for block 830 of FIG. 8.

At block 1305, the evaluation system accesses an engagement score (e.g., the engagement score 225 of FIG. 7) for a user. In some aspects, as discussed above, the evaluation system may access the engagement score in response to receiving a request from the user (e.g., when the user places an order requesting one or more items or services for their therapy).

At block 1310, the evaluation system determines a set of possible or candidate notification types that can be used for the user. For example, a discussed above, the evaluation system may determine whether the user is enrolled in (e.g., has opted in or has not opted out of) various mediums such as text messages, phone call, audio message, email, push notification, and the like.

At block 1315, the evaluation system selects one or more notification types (e.g., the notification type 705 of FIG. 7), from the set of candidate types, for the user based on the engagement score. In some embodiments, the evaluation system may also determine the frequency, delay, or other transmission characteristics for the interface based on the engagement score.

At block 1320, the evaluation system determines a set of possible or candidate GUI elements that can be included in the interface for the user. For example, as discussed above, the evaluation system may determine which element(s) may be included based on the nature or content of the interface, such as whether one or more payment options should be included, whether tips and tricks should be included, and the like.

At block 1325, the evaluation system selects a set of GUI elements (e.g., the GUI elements 710 of FIG. 7) to include in the interface. For example, as discussed above, the evaluation system may select the elements based On comparing the engagement score to one or more thresholds or rules (e.g., selecting particular elements for inclusion based on whether the score meets or exceeds a threshold).

At block 1330, the evaluation system determines or selects the GUI element arrangement(s) based on the engagement score. For example, as discussed above, the evaluation system may select a color, orientation, shape, size, emphasis, and any other visual characteristic of the GUI elements based on the score (e.g., to emphasize GUI elements that are likely to be most relevant to the user).

At block 1335, the evaluation system generates a GUI notification (e.g., the interface 115 of FIG. 7) in accordance with the determined and selected configurations, as discussed above. This interface may then be provided to the user to facilitate settlement of the request(s)

### Example Method for Generating Customized Interfaces

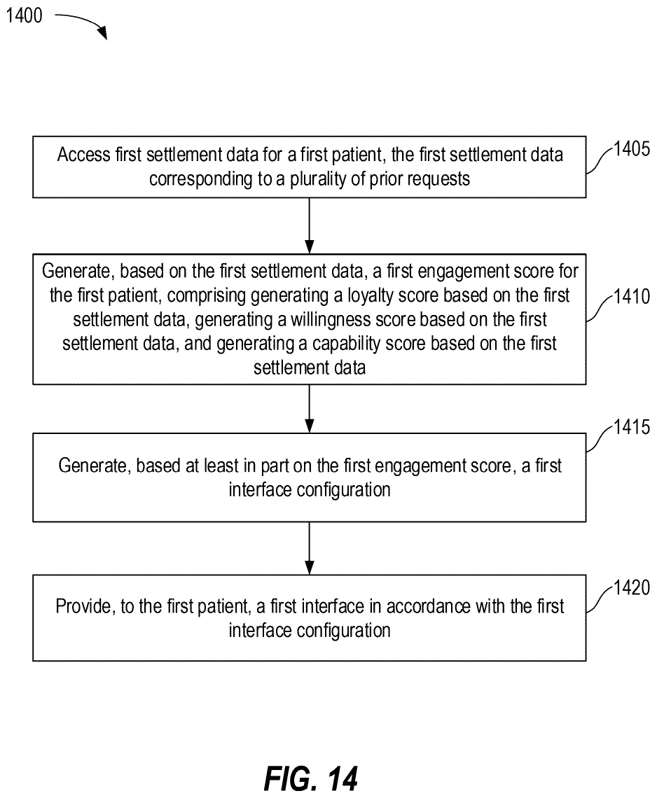

FIG. 14 is a flow diagram depicting an example method 1400 for generating customized interfaces, according to some embodiments of the present disclosure. In some embodiments, the method 1400 may be performed by an evaluation system, such as the evaluation system 105 of FIG. 1 and/or the evaluation systems discussed above with reference to FIGS. 2-13.

At block 1405, first settlement data (e.g., the settlement data 110 of FIGS. 1-5) for a first patient is accessed, the first settlement data corresponding to a plurality of prior requests.

At block 1410, based on the first settlement data, a first engagement score (e.g., the engagement score 225 of FIGS. 2, 6, and/or 7) is generated for the first patient, comprising generating a loyalty score (e.g., the loyalty score 335 of FIGS. 3 and/or 6) based on the first settlement data, generating a willingness score (e.g., the willingness score 435 of FIGS. 4 and/or 6) based on the first settlement data, and generating a capability score (e.g., the capability score 535 of FIGS. 5 and/or 6) based on the first settlement data.

At block 1415, based at least in part on the first engagement score, a first interface configuration (e.g., the notification type 710 and/or GUI elements 710 of FIG. 7) is generated.

At block 1420, a first interface (e.g., the interface 115 of FIGS. 1, 2, and/or 7) is provided, to the first patient, in accordance with the first interface configuration.

### Example Computing Device for Interface Generation

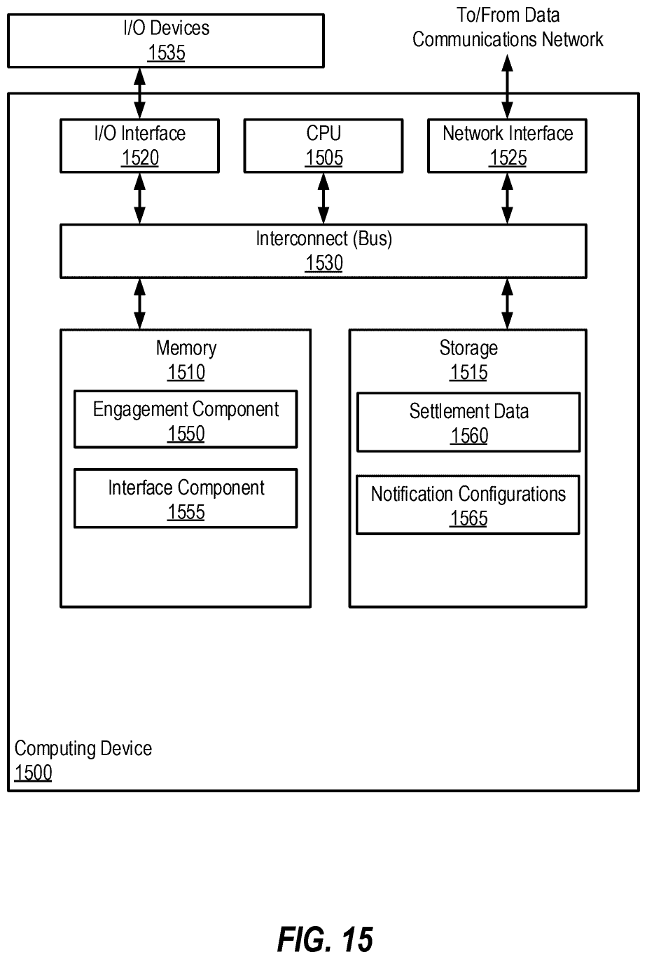

FIG. 15 depicts an example computing device 1500 configured to perform various embodiments of the present disclosure. Although depicted as a physical device, in embodiments, the computing device 1500 may be implemented using virtual device(s), and/or across a number of devices (e.g., in a cloud environment). In one embodiment, the computing device 1500 corresponds to an evaluation system, such as the evaluation system 105 of FIG. 1 and/or the evaluation systems discussed above with reference to FIGS. 2-14.

As illustrated, the computing device 1500 includes a CPU 1505, memory 1510, a network interface 1525, and one or more I/O interfaces 1520. In the illustrated embodiment, the CPU 1505 retrieves and executes programming instructions stored in memory 1510, as well as stores and retrieves application data residing in one or more storage repositories (not depicted). The CPU 1505 is generally representative of a single CPU and/or GPU, multiple CPUs and/or GPUs, a single CPU and/or GPU having multiple processing cores, and the like. The memory 1510 is generally included to be representative of a random access memory. In some embodiments, the computing device 1500 may include storage (not depicted) which may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 1535 (such as keyboards, monitors, etc.) are connected via the I/O interface(s) 1520. Further, via the network interface 1525, the computing device 1500 can be communicatively coupled with one or more other devices and components (e.g., via a network, which may include the Internet, local network(s), and the like). As illustrated, the CPU 1505, memory 1510, network interface(s) 1525, and I/O interface(s) 1520 are communicatively coupled by one or more buses 1530.

In the illustrated embodiment, the memory 1510 includes an engagement component 1550 and an interface component 1555, which may perform one or more embodiments discussed above. Although depicted as discrete components for conceptual clarity, in embodiments, the operations of the depicted components (and others not illustrated) may be combined or distributed across any number of components. Further, although depicted as software residing in memory 1510, in embodiments, the operations of the depicted components (and others not illustrated) may be implemented using hardware, software, or a combination of hardware and software.

In some embodiments, the engagement component 1550 (which may correspond to the engagement component 120 of FIGS. 1-2) may be used to generate engagement scores (e.g., the engagement score 225 of FIG. 2) for users based on corresponding settlement data (e.g., the settlement data 110 of FIG. 2), as discussed above. For example, the engagement component 1550 may generate sub-scores (such as a loyalty score, a willingness score, and/or a capability score) and/or aggregate these sub-scores to generate an overall engagement score for the user.

In some embodiments, the interface component 1555 (which may correspond to the interface component 125 of FIGS. 1-2) may be used to generate dynamic and customized interfaces (e.g., the interface 115 of FIG. 1) for users based on their engagement scores, as discussed above. For example, the interface component 1555 may generate interface configurations specifying characteristics and/or content of the interfaces, such as the type, frequency, elements included therein, design of each element, and the like in an effort to maximize (or at least increase) the probability that the user will engage with the interface (e.g., completing payment).

In the illustrated example, the storage 1515 includes settlement data 1560 and notification configurations 1565. In some embodiments, the settlement data 1560 (which may correspond to the settlement data 110 of FIGS. 1-5) includes information relating to prior requests (e.g., item or service orders) of one or more users, such as date(s) when the request was placed, the value or amount of each request, the date(s) when the invoice was paid or settled, and the like. The notification configurations 1565 may generally indicate the various configuration options that can be used to generate custom interfaces, such as the possible notification types, the GUI elements that can be dynamically included, and the like. Although depicted as residing in the storage 1515 for conceptual clarity, the settlement data 1560 and the notification configurations 1565 may be stored in any suitable location, including one or more local storage repositories, in the memory 1510, or in one or more remote systems distinct from the computing device 1500.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the embodiments set forth herein. In addition, the scope of the disclosure is intended to cover such an apparatus or method that is practiced using other structure, functionality, or structure and functionality in addition to, or other than, the various embodiments of the disclosure set forth herein. It should be understood that any embodiment of the disclosure disclosed herein may be embodied by one or more elements of a claim.

As used herein, the word “exemplary” means “serving as an example, instance, or illustration.” Any embodiment described herein as “exemplary” is not necessarily to be construed as preferred or advantageous over other embodiments.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications or systems (e.g., evaluation system 105 of FIG. 1) or related data available in the cloud. For example, the evaluation system could execute on a computing system in the cloud and generate engagement scores and dynamic interfaces for users. In such a case, the evaluation system could maintain the relevant data in the cloud, and use the generated scores to generate improved custom and dynamic interfaces for users. Doing so allows a user to access this information from any computing system attached to a network connected to the cloud (e.g., the Internet).

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

### EXAMPLE CLAUSES

Implementation examples are described in the following numbered clauses:

Clause 1: A method, comprising: accessing first settlement data for a first patient, the first settlement data corresponding to a plurality of prior requests; generating, based on the first settlement data, a first engagement score for the first patient, comprising; generating a loyalty score based on the first settlement data; generating a willingness score based on the first settlement data; and generating a capability score based on the first settlement data; generating, based at least in part on the first engagement score, a first interface configuration; and providing, to the first patient, a first interface in accordance with the first interface configuration.

Clause 2: The method of Clause 1, wherein generating the first interface configuration comprises selecting a first notification type from a plurality of notification types.

Clause 3: The method of Clause 2, wherein the plurality of notification types contain at least one of: (i) text message, (ii) email, (iii) push notification, (iv) telephone call, or (v) physical letter.

Clause 4: The method of any of Clauses 1-3, wherein selecting the first notification type comprises selecting a more intrusive notification type when the first engagement score is below a first threshold, as compared to a second notification type selected when the first engagement score is above the first threshold.

Clause 5: The method of any of Clauses 1-4, wherein: generating the first interface configuration comprises selecting a first graphical element, of a plurality of graphical elements, for a graphical user interface (GUI) based on the first engagement score, and providing the first interface comprises causing the first graphical element to be visually emphasized on the GUI.

Clause 6: The method of Clause 5, wherein generating the first graphical element comprises determining to emphasize a deferred settlement interaction element when the first engagement score is below a first threshold, as compared to an immediate settlement interaction element when the first engagement score is above the first threshold.

Clause 7: The method of any of Clause 1-6, wherein generating the loyalty score comprises: generating a settlement per day score based on the first settlement data; generating a frequency per day score based on the first settlement data; generating a longevity score based on the first settlement data; and generating a write-off score based on the first settlement data.

Clause 8: The method of any of Clauses 1-7, wherein the first settlement data comprises, for each respective request of the plurality of prior requests: a respective request date when the respective request was received, a respective amount of the respective request, and a respective settlement date when the respective request was settled.

Clause 9: The method of any of Clauses 1-8, further comprising: accessing second settlement data for a second patient; generating, based on the second settlement data, a second engagement score for the second patient; generating, based at least in part on the second engagement score, a second interface configuration; and providing, to the second patient, a second interface in accordance with the second interface configuration.

Clause 10: The method of any of Clauses 1-9, further comprising: in response to receiving, from the first patient, a new request, accessing second settlement data for the first patient; generating, based on the second settlement data, a second engagement score for the first patient; generating, based at least in part on the second engagement score, a second interface configuration; and providing, to the first patient, a second interface in accordance with the second interface configuration.

Clause 11: A system, comprising: a memory comprising computer-executable instructions; and one or more processors configured to execute the computer-executable instructions and cause the processing system to perform a method in accordance with any one of Clauses 1-10.

Clause 12: A system, comprising means for performing a method in accordance with any one of Clauses 1-10.

Clause 13: A non-transitory computer-readable medium comprising computer-executable instructions that, when executed by one or more processors of a processing system, cause the processing system to perform a method in accordance with any one of Clauses 1-10.

Clause 14: A computer program product embodied on a computer-readable storage medium comprising code for performing a method in accordance with any one of Clauses 1-10.

What is claimed is:

1. A method, comprising:
accessing first settlement data for a first patient, the first settlement data corresponding to a plurality of prior requests;
generating, based on the first settlement data, a first engagement score for the first patient, comprising:
generating a loyalty score based on the first settlement data;
generating a willingness score based on the first settlement data; and
generating a capability score based on the first settlement data;
generating, based at least in part on the first engagement score, a first interface configuration; and
providing, to the first patient, a first interface in accordance with the first interface configuration.

2. The method of claim 1, wherein generating the first interface configuration comprises selecting a first notification type from a plurality of notification types.

3. The method of claim 2, wherein the plurality of notification types contain at least one of: (i) text message, (ii) email, (iii) push notification, (iv) telephone call, or (v) physical letter.

4. The method of claim 2, wherein selecting the first notification type comprises selecting a more intrusive notification type when the first engagement score is below a first threshold, as compared to a second notification type selected when the first engagement score is above the first threshold.

5. The method of claim 1, wherein:
generating the first interface configuration comprises selecting a first graphical element, of a plurality of graphical elements, for a graphical user interface (GUI) based on the first engagement score, and
providing the first interface comprises causing the first graphical element to be visually emphasized on the GUI.

6. The method of claim 5, wherein generating the first graphical element comprises determining to emphasize a deferred settlement interaction element when the first engagement score is below a first threshold, as compared to an immediate settlement interaction element when the first engagement score is above the first threshold.

7. The method of claim 1, wherein generating the loyalty score comprises:
generating a settlement per day score based on the first settlement data;
generating a frequency per day score based on the first settlement data;
generating a longevity score based on the first settlement data; and
generating a write-off score based on the first settlement data.

8. The method of claim 1, wherein the first settlement data comprises, for each respective request of the plurality of prior requests:
a respective request date when the respective request was received,
a respective amount of the respective request, and
a respective settlement date when the respective request was settled.

9. The method of claim 1, further comprising:
accessing second settlement data for a second patient;
generating, based on the second settlement data, a second engagement score for the second patient;
generating, based at least in part on the second engagement score, a second interface configuration; and
providing, to the second patient, a second interface in accordance with the second interface configuration.

10. The method of claim 1, further comprising:
in response to receiving, from the first patient, a new request, accessing second settlement data for the first patient;
generating, based on the second settlement data, a second engagement score for the first patient;
generating, based at least in part on the second engagement score, a second interface configuration; and
providing, to the first patient, a second interface in accordance with the second interface configuration.

11. A processing system, comprising:
one or more processors; and
one or more memories collectively comprising computer-executable instructions which, when executed on any combination of the one or more processors, cause the processing system to perform an operation comprising:
accessing first settlement data for a first patient, the first settlement data corresponding to a plurality of prior requests;
generating, based on the first settlement data, a first engagement score for the first patient, comprising:
generating a loyalty score based on the first settlement data;
generating a willingness score based on the first settlement data; and
generating a capability score based on the first settlement data;
generating, based at least in part on the first engagement score, a first interface configuration; and
providing, to the first patient, a first interface in accordance with the first interface configuration.

12. The processing system of claim 11, wherein selecting the first notification type comprises selecting a more intrusive notification type when the first engagement score is below a first threshold, as compared to a second notification type selected when the first engagement score is above the first threshold.

13. The processing system of claim 11, wherein:
generating the first interface configuration comprises selecting a first graphical element, of a plurality of graphical elements, for a graphical user interface (GUI) based on the first engagement score, and
providing the first interface comprises causing the first graphical element to be visually emphasized on the GUI.

14. The processing system of claim 13, wherein generating the first graphical element comprises determining to emphasize a deferred settlement interaction element when the first engagement score is below a first threshold, as compared to an immediate settlement interaction element when the first engagement score is above the first threshold.

15. The processing system of claim 11, the operation further comprising:
accessing second settlement data for a second patient;
generating, based on the second settlement data, a second engagement score for the second patient;
generating, based at least in part on the second engagement score, a second interface configuration; and
providing, to the second patient, a second interface in accordance with the second interface configuration.

16. One or more non-transitory computer readable media collectively containing, in any combination, computer program code that, when executed by operation of a computing system, performs an operation comprising:
accessing first settlement data for a first patient, the first settlement data corresponding to a plurality of prior requests;
generating, based on the first settlement data, a first engagement score for the first patient, comprising:
generating a loyalty score based on the first settlement data;
generating a willingness score based on the first settlement data; and
generating a capability score based on the first settlement data;
generating, based at least in part on the first engagement score, a first interface configuration; and
providing, to the first patient, a first interface in accordance with the first interface configuration.

17. The one or more non-transitory computer readable media of claim 16, wherein selecting the first notification type comprises selecting a more intrusive notification type when the first engagement score is below a first threshold, as compared to a second notification type selected when the first engagement score is above the first threshold.

18. The one or more non-transitory computer readable media of claim 16, wherein:
generating the first interface configuration comprises selecting a first graphical element, of a plurality of graphical elements, for a graphical user interface (GUI) based on the first engagement score, and
providing the first interface comprises causing the first graphical element to be visually emphasized on the GUI.

19. The one or more non-transitory computer readable media of claim 18, wherein generating the first graphical element comprises determining to emphasize a deferred settlement interaction element when the first engagement score is below a first threshold, as compared to an immediate settlement interaction element when the first engagement score is above the first threshold.

20. The one or more non-transitory computer readable media of claim 16, the operation further comprising:
accessing second settlement data for a second patient;
generating, based on the second settlement data, a second engagement score for the second patient;
generating, based at least in part on the second engagement score, a second interface configuration; and
providing, to the second patient, a second interface in accordance with the second interface configuration.
